(19) United States
(12) Patent Application Publication
(10) Pub. No.: US 2016/0362557 A1
(43) Pub. Date: Dec. 15, 2016

(54) LONG LIFE LOW COST ENVIRONMENTAL BARRIER COATING FOR CERAMIC MATRIX COMPOSITES

(71) Applicant: Rolls-Royce Corporation, Indianapolis, IN (US)

(72) Inventor: Kang N. Lee, Zionsville, IN (US)

(21) Appl. No.: 14/193,467

(22) Filed: Feb. 28, 2014

Related U.S. Application Data
(60) Provisional application No. 61/772,661, filed on Mar. 5, 2013.

(51) Int. Cl. C09D 1/02

(52) U.S. Cl. CPC C09D 1/02

(57) ABSTRACT

An environmental barrier coating composition for a ceramic matrix composite is provided that includes a doped rare earth disilicate layer over the ceramic matrix composite. The doped rare earth disilicate includes a disilicate having a composition of RE₂Si₂O₇. The RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium.

### RELATED APPLICATIONS

This application is related to and claims priority to U.S. Provisional Patent Application Ser. No. 61/772.661, filed on Mar. 5, 2013 entitled “Long Life Low Cost Environmental Barrier Coating For Ceramic Matrix Composites,” The subject matter disclosed in that provisional application is hereby expressly incorporated into the present application in its entirety.

### FIELD OF DISCLOSURE

The present disclosure relates generally to environmental barrier coatings and, more specifically, to long life, low cost barrier coatings for ceramic matrix composites used in high-temperature mechanical systems such as gas turbine engines.

### BACKGROUND

A gas turbine engine, such as an aircraft engine, operates in severe environments. For example, high-pressure turbine blades and vanes are exposed to hot gases that experience metal surface temperatures of about 1000° C. with short-term peaks as high as 1100° C.

Ceramic matrix composite (CMC) components have excellent high temperature mechanical, physical, and chemical properties which allow gas turbine engines to operate at much higher temperatures than current engines with superalloy components. An issue with CMC components, however, is their lack of environmental durability in combustion environments. Water vapor, a combustion reaction product, reacts with protective silica scale on silicon carbide/silicon carbide (SiC/SiC) CMCs or alumina matrix in oxide/oxide CMCs, forming gaseous reaction products such as Si(OH)₄ and Al(OH)₃, respectively. In high pressure, high gas velocity gas turbine environments, this reaction may result in surface recession of the CMC.

The present disclosure includes embodiments of long life, low cost, environmental barrier coatings (EBCs) for ceramic matrix composites (CMOs). An illustrative embodiment of the present disclosure provides an environmental barrier coating composition for a ceramic matrix composite. The coating comprises a doped rare earth disilicate layer and a ceramic matrix composite. The doped rare earth disilicate layer is located over the ceramic matrix composite, and includes a disilicate having a composition of RE₂Si₂O₇. The RE is selected from the group consisting of at least one of lutetium, ytterbium, thulium, erbium, holmium, dysprosium, terbium, gadolinium, europium, samarium, promethium, neodymium, praseodymium, ceeium, lanthanum yttrium, and scandium. In addition, the doped rare earth disilicate layer includes a dopant selected from the group consisting of at least one of an Al₂O₃, alkali oxide, and alkali earth oxide, and the dopant is present in an amount between about 0.1 wt % and about 5 wt %. The balance of the doped rare earth disilicate layer is the disilicate.

In the above and other embodiments disclosed herein, the environmental barrier coating composition may further comprise: the dopant being the Al₂O which is present in an amount between about 0.5 wt % and about 3 wt %; the dopant being the Al₂O₃ which is present in an amount between about 0.5 wt % and about 1 wt %; the dopant being the alkali oxide which is present in an amount between about 0.1 wt % and about 1 wt %; the dopant being the alkali earth oxide which is present in an amount between about 0.1 wt % and about 1 wt %; an uppermost top coat selected from the group consisting of a rare earth disilicate layer, a rare earth monosilicate layer, a dual-layered coat including rare earth monosilicate layer over a rare earth disilicate layer, and a rare earth disilicate and rare earth monosilicate layer; wherein the rare earth disilicate has a composition of RE₂Si₂O₇, wherein RE is selected from the group consisting of at least one of lutetium, ytterbium thulium, erbium, holmium, dysprosium, terbium, gadolinium, europium, samarium, promethium, neodymium, praseodymium, cerium, lanthanum, yttrium, and scandium; and the monosilicate has a composition of RE₂SiO₅, wherein RE is selected from the group consisting of at least one of lutetium, ytterbium thulium, erbium, holmium, dysprosium, terbium, gadolinium, europium, samarium, promethium, neodymium, praseodymium, cerium, lanthanum, yttrium, and scandium; the doped rare earth disilicate layer having a thickness of between about 0.5 mils to about 10 mils; and the doped rare earth disilicate layer having a thickness of between about 1 mil to about 3 mils.

Another illustrative embodiment includes an environmental barrier coating composition for a ceramic matrix composite comprising a doped rare earth disilicate layer, a ceramic matrix composite, and a silicon coat layer. The doped rare earth disilicate layer is located over the silicon coat layer. The silicon coat layer is located between the doped rare earth disilicate layer and the ceramic matrix composite. The doped rare earth disilicate layer includes a disilicate that has a composition of RE₂Si₂O₇, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. In addition, the doped rare earth disilicate layer includes a dopant selected from the group consisting of at least one of an Al₂O₃, alkali oxide, and alkali earth oxide. Lastly, the dopant is present in an amount between about 0.1 wt % and about 5 wt %, and the balance being the disilicate.

Another illustrative embodiment includes an environmental barrier coating composition for a ceramic matrix composite that comprises a calcium-magnesium aluminosilicate-resistant layer and a doped rare earth disilicate layer. The calcium-magnesium aluminosilicate-resistant layer is located over the doped rare earth disilicate layer. The doped rare earth disilicate layer is located between the calcium-magnesium aluminosilicate-resistant layer and the ceramic matrix composite. The doped rare earth disilicate layer includes a disilicate that has a composition of RE₂Si₂O₇, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The doped rare earth disilicate layer includes a dopant selected from the group consisting of at least one of an Al₂O₃, alkali oxide, and alkali earth oxide present in an amount between about 0.1 wt % and about 5 wt %. The balance of the doped rare earth disilicate layer is the disilicate. The calcium-magnesium aluminosilicate-resistant layer comprises a rare earth oxide, alumina, and silica wherein the rare earth oxide has a composition of RE₂O₃. RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The calcium-magnesium aluminosilicate-resistant layer includes a dopant that includes Al₂O₃ and SiO₂. The Al₂O₃ in the calcium-magnesium aluminosilicate-resistant layer is present in an amount between about 0.1 wt % and about 5 wt % and the SiO₂ is present in an amount between about 5 wt % and about 25 wt %. The balance is the rare earth oxide.

In the above and other embodiments disclosed herein, the environmental barrier coating composition may further comprise: the calcium-magnesium aluminosilicate-resistant layer further comprising an oxide selected from the group consisting of at least one of Ta₂O₅, TiO₂, HfSiO₄, an alkali oxide, and an alkali earth oxide; the Al₂O₃ in the calcium-magnesium aluminosilicate-resistant layer being present in an amount between about 0.5 wt % and about 3 wt % and the SiO₂ being present in an amount between about 5 wt % and about 20 wt %; the Al₂O₃ in the calcium-magnesium aluminosilicate-resistant layer being present in an amount between about 0.5 wt % and about 1 wt % and the SiO₂ being present in an amount between about 10 wt % and about 20 wt %; the oxide of the calcium-magnesium aluminosilicate-resistant layer being present in an amount between about 0.1 wt % and about 3 wt %; the oxide of the calcium-magnesium aluminosilicate-resistant layer being present in an amount between about 0.5 wt % and about 1 wt %; the calcium-magnesium aluminosilicate-resistant layer having a thickness of between about 0.5 mils to about 10 mils; the calcium-magnesium aluminosilicate-resistant layer having a thickness of between about 1 mil to about 3 mils; the dopant in the doped rare earth disilicate layer being the Al₂O₃ which is present in an amount between about 0.5 wt % and about 3 wt %; the dopant in the doped rare earth disilicate layer being the Al₂O₃ which is present in an amount between about 0.5 wt % and about 1 wt %; the dopant in the doped rare earth disilicate layer being the alkali oxide which is present in an amount between about 0.1 wt % and about 1 wt %; the dopant in the doped rare earth disilicate layer being the alkali earth oxide which is present in an amount between about 0.1 wt % and about 1 wt %; an uppermost top coat selected from the group consisting of a rare earth disilicate layer, a rare earth monosilicate layer, a dual-layered coat including a rare earth monosilicate layer over a rare earth disilicate layer, and a rare earth disilicate and rare earth monosilicate layer; wherein the rare earth disilicate has a composition of RE₂Si₂O₇, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium; and the monosilicate has a composition of RE₂SiO₅, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium; the doped rare earth disilicate layer having a thickness of between about 0.5 mils to about 10 mils; the doped rare earth disilicate layer having a thickness of between about 1 mil to about 3 mils.

Another illustrative embodiment includes an environmental barrier coating composition for a ceramic matrix composite that comprises a barium-strontium-aluminosilicate layer and a doped rare earth disilicate layer. The barium-strontium-aluminosilicate layer is located over the doped rare earth disilicate layer. The doped rare earth disilicate layer is located between the barium-strontium-aluminosilicate layer and the ceramic matrix composite. The doped rare earth disilicate layer includes a disilicate that has a composition of RE₂Si₂O₇, wherein RE is selected from the group consisting of at least one of lutetium, ytterbium, thulium, erbium, holmium, dysprosium terbium, gadolinium, europium, samarium, promethium, neodymium, praseodymium, cerium, lanthanum, yttrium, and scandium. The doped rare earth disilicate layer includes a dopant selected from the group consisting of at least one of an Al₂O₃, alkali oxide, and alkali earth oxide, and is present in are amount between about 0.1 wt % and about 5 wt %, and the balance of the doped rare earth disilicate layer being the disilicate; the dopant being the Al₂O₃ which is present in as amount between about 0.5 wt % and about 3 wt %; the dopant being the Al₂O₃ which is present in an amount between about 0.5 wt % and about 1 wt %; the dopant is the alkali oxide being present in an amount between 0.1 wt % and 1 wt %; the dopant being the alkali earth oxide which is present in an amount between about 0.1 wt % and about 1 wt %; the doped rare earth disilicate layer having a thickness of between about 0.5 mils to about 10 mils; and the doped rare earth disilicate layer having a thickness of between about 1 mil to about 3 mils.

Another illustrative embodiment includes an environmental barrier coating composition for a ceramic matrix composite that comprises a barium-strontium-aluminosilicate layer, a doped rare earth disilicate layer, and a silicon coat layer. The barium-strontium-aluminosilicate layer is located over the doped rare earth disilicate layer. The doped rare earth disilicate layer is located between the barium-strontium-aluminosilicate layer and the silicon coat layer. The silicon coat layer is located between the doped rare earth disilicate layer and the ceramic matrix composite. The doped rare earth disilicate layer includes a disilicate that has a composition of RE₂Si₂O₇, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The doped rare earth disilicate layer includes a dopant selected from the group consisting of at least one of an Al₂O₃, alkali oxide, and alkali earth oxide. The dopant is present in an amount between about 0.1 wt % and about 5 wt %, and the balance being the disilicate.

Another illustrative embodiment includes an environmental barrier coating composition for a ceramic matrix composite that comprises a barium-strontium-aluminosilicate layer, a calcium-magnesium aluminosilicate-resistant layer, and a doped rare earth disilicate layer. The barium-strontium-aluminosilicate layer is located over the calcium-magnesium aluminosilicate-resistant layer. The calcium-magnesium aluminosilicate-resistant layer is located between the barium-strontium-aluminosilicate layer and the doped rare earth disilicate layer. The doped rare earth disilicate layer is located between the calcium-magnesium aluminosilicate-resistant layer and the ceramic matrix composite. The doped rare earth disilicate layer includes a disilicate that has a composition of RE₂Si₂O₇, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The doped rare earth disilicate layer includes a dopant selected from the group consisting of at least one of an Al₂O₃, alkali oxide, and alkali earth oxide. The dopant is present in an amount between about 0.1 wt % and about 5 wt %, and the balance being the disilicate. The calcium-magnesium aluminosilicate-resistant layer comprises a rare earth oxide, alumina, and silica wherein the rare earth oxide has a composition of RE₂O₃, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The calcium-magnesium aluminosilicate-resistant layer includes a dopant that includes Al₂O₃ and SiO₂. The Al₂O₃ in the calcium-magnesium aluminosilicate-resistant layer is present in an amount between about 0.1 wt % and about 5 wt %. The SiO₂ in the calcium-magnesium aluminosilicate-resistant layer is present in an amount between about 5 wt % and about 25 wt % with the balance being the rare earth oxide.

In the above and other embodiments disclosed herein, the environmental barrier coating composition may further comprise: the calcium-magnesium aluminosilicate-resistant layer further comprising an oxide selected from the group consisting of at least one of Ta₂O₅, TiO₂ HfSiO₄ an alkali oxide, and an alkali earth oxide; the Al₂O₃ in the calcium-magnesium aluminosilicate-resistant layer being present in an amount between about 0.5 wt % and about 3 wt % and the SiO₂ being present in an amount between about 5 wt % and about 20 wt %; the Al₂O₃ in the calcium-magnesium aluminosilicate-resistant layer being present in an amount between about 0.5 wt % and about 1 wt % and the SiO₂ being present in an amount between about 10 wt % and about 20 wt %; the oxide of the calcium-magnesium aluminosilicate-resistant layer being present in an amount between about 0.1 wt % and about 3 wt %; the oxide of the calcium-magnesium aluminosilicate-resistant layer being present in an amount between about 0.5 wt % and about 1 wt %; the calcium-magnesium aluminosilicate-resistant layer has a thickness of between about 0.5 mils to about 10 mils; the calcium-magnesium aluminosilicate-resistant layer having a thickness of between about 1 mil to about 3 mils; the dopant in the doped rare earth disilicate layer being the Al₂O₃ which is present in an amount between about 0.5 wt % and about 3 wt % the dopant in the doped rare earth disilicate layer being the Al₂O₃ which is present in an amount between about 0.5 wt % and about 1 wt %; the dopant in the doped rare earth disilicate layer being the alkali oxide which is present in an amount between about 0.1 wt % and about 1 wt %; the dopant in the doped rare earth disilicate layer being the alkali earth oxide which is present in an amount between about 0.1 wt % and about 1 wt %; the doped rare earth disilicate layer having a thickness of between about 0.5 mils to about 10 mils; the doped rare earth disilicate layer having a thickness of between about 1 mil to about 3 mils.

Another illustrative embodiment includes an environmental barrier coating composition for a ceramic matrix composite that comprises a barium-strontium-aluminosilicate layer, a calcium-magnesium aluminosilicate-resistant layer, and a doped rare earth disilicate layer. The calcium-magnesim aluminosilicate-resistant layer is located over the barium-strontium-aluminosilicate layer. The barium-strontium-aluminosilicate layer is located between the calcium-magnesium aluminosilicate-resistant layer and the doped rare earth disilicate layer. The doped rare earth disilicate layer is located between the barium-strontium-aluminosilicate layer and the ceramic matrix composite. The doped rare earth disilicate layer includes a disilicate that has a composition of RE₂Si₂O₇, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The doped rare earth disilicate layer includes a dopant selected from the group consisting of at least one of an Al₂O₃, alkali oxide, and alkali earth oxide. The dopant is present in an amount between about 0.1 wt % and about 5 wt % with the balance being the disilicate. The calcium-magnesium aluminosilicate-resistant layer comprises a rare earth oxide, alumina, and silica wherein the rare earth oxide has a composition of RE₂O₃, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The calcium-magnesium aluminosilicate-resistant layer includes a dopant that includes Al₂O₃ and SiO₂. The Al₂O₂ in the calcium-magnesium aluminosilicate-resistant layer is present in an amount between about 0.1 wt % and about 5 wt %, wherein the SiO₂ in the calcium-magnesium aluminosilicate-resistant layer is present in an amount between about 5 wt % and about 25 wt % with the balance being the rare earth oxide.

Another illustrative embodiment includes an environmental barrier coating composition for a ceramic matrix composite that comprises a calcium-magnesium aluminosilicate-resistant layer, a doped rare earth disilicate layer, and a silicon coat layer. The calcium-magnesium aluminosilicate-resistant layer is located over the doped rare earth disilicate layer. The doped rare earth disilicate layer is located between the calcium-magnesium aluminosilicate-resistant layer and the silicon coat layer. The silicon coat layer is located between the doped rare earth disilicate layer and the ceramic matrix composite. The doped rare earth disilicate layer includes a disilicate that has a composition of RE₂Si₂O₇, wherein RE is selected from the group consisting of at least one of lutetium, ytterbium, thulium, erbium, holmium, dysprosium, terbium, gadolinium, europium, samarium, promethium, neodymium praseodymium, cerium, lanthanum, yttrium, and scandium. The doped rare earth disilicate layer includes a dopant selected from the group consisting of at least one of an Al₂O₃, alkali oxide, and alkali earth oxide. The dopant is present in an amount between about 0.1 wt % and about 5 and the balance of the doped rare earth disilicate layer being the disilicate. The calcium-magnesium aluminosilicate-resistant layer comprises a rare earth oxide, alumina, and silica, wherein the rare earth oxide has a composition of RE₂O₃, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The calcium-magnesium aluminosilicate resistant layer includes a dopant that includes Al₂O₃ and SiO₃. The Al₂O₃ in the calcium-magnesium aluminosilicate-resistant layer is present in an amount between about 0.1 wt % and about 5 wt %, and the SiO₂ is present in an amount between about 5 wt % and about 25 wt % with the balance being the rare earth oxide.

In the above and other embodiments disclosed herein, the environmental barrier coating composition may further comprise: the calcium-magnesium aluminosilicate-resistant layer further comprising an oxide selected from the group consisting of at least one of Ta₂O₅, TiO₂, HfSiO₄, an alkali oxide, and an alkali earth oxide; the Al₂O₃ in the calcium-magnesium aluminosilicate-resistant layer being present in an amount between about 0.5 wt % and about 3 wt % and the SiO₂ being present in an amount between about 5 wt % and about 20 wt %; the Al₂O₃ in the calcium-magnesium aluminosilicate-resistant layer being sent in an amount between about 0.5 wt % and about 1 wt % and the SiO₂ being present in an amount between about 10 wt % and about 20 wt %; the oxide of the calcium-magnesium aluminosilicate-resistant layer being present in an amount between about 0.1 wt % and about 3 wt %; the oxide of the calcium-magnesium aluminosilicate-resistant layer being present in an amount between about 0.5 wt % and about 1 wt %; the calcium-magnesium aluminosilicate-resistant layer having a thickness of between about 0.5 mils to about 10 mils; the calcium-magnesium aluminosilicate-resistant layer having a thickness of between about 1 mil to about 3 mils: the dopant in the doped rare earth disilicate layer having the Al₂O₃ which is present in an amount between about 0.5 wt % and about 3 wt %; the dopant in the doped rare earth disilicate layer being the Al₂O₃ which is present in an amount between about 0.5 wt % and about 1 wt %; the dopant in the doped rare earth disilicate layer being the alkali oxide which is present in an amount between about 0.1 wt % and about 1 wt %; the dopant in the doped rare earth disilicate layer being the alkali earth oxide which is present in an amount between about 0.1 wt % and about 1 wt %; an uppermost top coat selected from the group consisting of a rare earth disilicate layer, a rare earth monosilicate layer; a dual-layered coat including a rare earth monosilicate layer over a rare earth disilicate layer, and a rare earth disilicate and rare earth monosilicate layer; wherein the rare earth disilicate has a composition of RE₂Si₂O₇, wherein RE is selected from the group consisting of at least one of lutetium, ytterbium, thulium erbium holmium, dysprosium, terbium, gadolinium, europium; samarium, promethium, neodymium, praseodymium, cerium lanthanum, yttrium, and scandium; and the monosilicate has a composition of RE₂SiO₅, wherein RE is selected from the group consisting of at least one of lutetium, ytterbium: thulium, erbium, holmium, dysprosium, terbium, gadolinium, europium, samarium, promethium, neodymium, praseodymium, cerium, lanthanum, yttrium and scandium; the doped rare earth disilicate layer having a thickness of between about 0.5 mils to about 10 mils; and the doped rare earth disilicate layer having a thickness of between about 1 mil to about 3 mils.

Another illustrative embodiment includes an environmental harrier coating composition for a ceramic matrix composite that comprises a barium-strontium-aluminosilicate layer, a calcium-magnesium aluminosilicate-resistant layer, a doped rare earth disilicate layer, and a silicon coat layer. The barium-strontium-aluminosilicate layer is located over the calcium-magnesium aluminosilicate-resistant layer. The calcium-magnesium aluminosilicate-resistant layer is located between the barium-strontium-aluminosilicate layer and the doped rare earth disilicate layer. The doped rare earth disilicate layer is located between the calcium-magnesium aluminosilicate-resistant layer and the silicon coat layer. The silicon coat layer is located between the doped rare earth disilicate layer and the ceramic matrix composite. The doped rare earth disilicate layer includes a disilicate that has a composition of RE₂Si₂O₇, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The doped rare earth disilicate layer includes a dopant selected from the group consisting of at least one of an Al₂O₃, alkali oxide, and alkali earth oxide. The dopant is present in an amount between about 0.1 wt % and about wt %, and the balance of the doped rare earth disilicate layer being the disilicate. The calcium-magnesium aluminosilicate-resistant layer comprises a rare earth oxide, alumina, and silica wherein the rare earth oxide has a composition of RE₂O₃, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The calcium-magnesium aluminosilicate-resistant layer includes a dopant that includes Al₂O₃ and SiO₂. The Al₂O₃ in the calcium-magnesium aluminosilicate-resistant layer is present in an amount between about 0.1 wt % and about 5 wt %. The SiO₂ in the calcium-magnesium aluminosilicate-resistant layer is present in an amount between about 5 wt % and about 25 wt % with the balance being the rare earth oxide.

Another illustrative embodiment includes an environmental barrier coating composition for a ceramic matrix composite that comprises a barium-strontium-aluminosilicate layer, a calcium-magnesium aluminosilicate-resistant layer, a doped rare earth disilicate layer, and a silicon coat layer. The calcium-magnesium aluminosilicate-resistant layer is located over the barium-strontium-aluminosilicate layer. The barium-strontium-aluminosilicate layer is located between the calcium-magnesium aluminosilicate-resistant layer and the doped rare earth disilicate layer. The doped rare earth disilicate layer is located between the barium-strontium-aluminosilicate layer and the silicon coat layer. The silicon coat layer is located between the doped rare earth disilicate layer and the ceramic matrix composite. The doped rare earth disilicate layer includes a disilicate that has a composition of RE₂Si₂O₇, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum yttrium, and scandium. The doped rare earth disilicate layer includes a dopant selected from the group consisting of at least one of an Al₂Oₐ, alkali oxide, and alkali earth oxide. The dopant is present in an amount between about 0.1 wt % and about 5 wt %, and the balance of the doped rare earth disilicate layer being the disilicate. The calcium-magnesium aluminosilicate-resistant layer comprises a rare earth oxide, alumina, and silica wherein the rare earth oxide has a composition of RE₂O₃, wherein RE is selected from the group consisting of at least one of lutetium, ytterbium, thulium, erbium, holmium, dysprosium, terbium, gadolinium, europium, samarium, promethium, neodymium, praseodymium, cerium, lanthanum, yttrium, and scandium. The calcium-magnesium aluminosilicate-resistant layer includes a dopant that includes Al₂O₃ and SiO₂. The Al₂Oₐ in the calcium-magnesium aluminosilicate-resistant layer is present in an amount between about 0.1 wt % and about 5 wt %, and the SiO₂ is present in an amount between about 5 wt % and about 25 wt %, with the balance being the rare earth oxide.

Additional features and advantages of the environmental barrier coatings will become apparent to those skilled in the art upon consideration of the following detailed descriptions exemplifying the best mode of carrying out the environmental barrier coatings as presently perceived.

### BRIEF DESCRIPTION OF DRAWINGS

The present disclosure will be described hereafter with reference to the attached drawings which are given as non-limiting examples only, in which:

FIG. 1 is a cross-sectional diagram of a ceramic matrix composite material coated with a doped rare earth disilicate layer;

FIG. 2 is a cross-sectional diagram of another ceramic matrix composite material coated with a doped rare earth disilicate layer over a silicon bond coat layer;

FIG. 3 is a cross-sectional diagram of another ceramic matrix composite material coated with a rare earth monosilicate and disilicate layer over a doped rare earth disilicate layer;

FIG. 4 is a cross-sectional diagram of another ceramic matrix composite material coated with a rare earth disilicate and monosilicate layer over a doped rare earth disilicate layer over a silicon bond coat;

FIG. 5 is a cross-sectional diagram of another ceramic matrix composite material coated with a rare earth disilicate layer over a doped rare earth disilicate layer;

FIG. 6 is a cross-sectional diagram of another ceramic matrix composite material coated with a rare earth disilicate layer over a doped rare earth disilicate layer over a silicon bond coat;

FIG. 7 is a cross-sectional diagram of another ceramic matrix composite material coated with a rare earth monosilicate layer over a doped rare earth disilicate layer;

FIG. 8 is a cross-sectional diagram of another ceramic matrix composite material coated with a rare earth monosilicate layer over a doped rare earth disilicate layer over a silicon bond coat;

FIG. 9 is a cross-sectional diagram of another ceramic matrix composite material coated with a rare earth monosilicate layer over a rare earth disilicate layer over a doped rare earth disilicate layer;

FIG. 10 is a cross-sectional diagram of another ceramic matrix composite material coated with a rare earth monosilicate layer over a rare earth disilicate layer over a doped rare earth disilicate layer over a silicon bond coat;

FIG. 11 is a cress-sectional diagram of another ceramic matrix composite material with a calcium-magnesium aluminosilicate-resistant layer over a doped rare earth disilicate layer;

FIG. 12 is a cross-sectional diagram of another ceramic matrix composite material coated with a calcium-magnesium aluminosilicate-resistant layer over a doped rare earth disilicate layer, over a silicon bond coat layer;

FIG. 13 a cross-sectional diagram of another ceramic matrix composite material coated with a barium-strontium-aluminosilicate layer over a doped rare earth disilicate layer;

FIG. 14 is a cross-sectional diagram of another ceramic matrix composite material coated with a barium-strontium-aluminosilicate layer over a doped rare earth disilicate layer over a silicon bond coat;

FIG. 15 is a cross-sectional diagram of another ceramic matrix composite material coated with a barium-strontium-aluminosilicate layer over a calcium-magnesium aluminosilicate-resistant layer over a doped rare earth disilicate layer;

FIG. 16 is a cross-sectional diagram of another ceramic matrix composite material coated with a calcium-magnesium aluminosilicate-resistant layer over a barium-strontium-aluminosilicate layer, over a doped rare earth disilicate layer;

FIG. 17 is a cross-sectional diagram of another ceramic matrix composite material coated with a calcium-magnesium aluminosilicate-resistant layer over a barium-strontium-aluminosilicate layer, over a doped rare earth disilicate layer, over a silicon bond coat;

FIG. 18 is a cross-sectional diagram of another ceramic matrix composite material coated with a barium-strontium-aluminosilicate layer over a calcium-magnesium aluminosilicate-resistant layer over a doped rare earth disilicate layer, over a silicon bond coat; and

FIG. 19 is a cross-sectional diagram of an illustrative three-dimensional surface ceramic matrix composite material illustratively coated with a barium-strontium-aluminosilicate over a doped rare earth disilicate layer, over a silicon bond coat.

Corresponding reference characters indicate corresponding parts throughout the several views. The exemplification set out herein illustrates embodiments of the environmental barrier coatings, and such exemplification is not to be construed as limiting the scope of the disclosure in any manner.

### DETAILED DESCRIPTION

The present disclosure relates to low cost, long life environmental barrier coatings (EBC) for ceramic matrix composites (CMCs). A doped rare earth disilicate layer or bond coat includes at least one of the rare earth disilicates (i.e., RE2Si₂O₇ wherein RE=at least one of lutetium, ytterbium, thulium, erbium, holmium, dysprosium, terbium, gadolinium, europium, sambarium, promethium, neodymium, praseodymium, cerium lanthanum, yttrium, and scandium) and is doped with at least one of Al₂O₃, alkali oxides, and alkali earth oxides. This coat is applied over a silicon bond coat layer. Doping with at least one of Al₂O₃ alkali oxides and alkali earth oxides improves the oxidation life of the EBC-coated CMC system by providing chemical bonding. The silicon bond coat may be applied between the doped rare earth disilicatee bond coat and the CMC substrate to further improve the bonding.

An illustrative embodiment, as shown in FIG. 1, includes a long life, low cost environmental barrier coat system 2 that incorporates a doped rare earth disilicate layer 4 over CMC layer 6. In one embodiment, the rare earth element may be ytterbium (Yb). It is appreciated, however, that other rare earth elements, such as lutetium, thulium, erbium, holmium, dysprosium, terbium, gadolinium, europium, samarium, promethium, neodymium, praseodymium, cerium, lanthanum, yttrium and scandium may be included.

The thickness of the doped rare earth disilicate layer 4 may also be kept at the minimum, i.e., enough to form continuous coverage of CMC layer 6—about 1 mil to about 3 mils for plasma-sprayed, coating and about 1 mil for electron beam, physical vapor deposition (EB-PVD) or direct vapor deposition (DVD) processed coating, in further embodiments, rare earth disilicate layer 4 may also have a thickness of between about 0.5 mils to about 10 mils.

Illustratively, the CMC substrate may include one of the following: a Si-containing ceramic such as silicon carbide (SiC) or silicon nitride (Si₃N₄); a SiC or Si₃N₄ matrix, silicon oxynitride, and silicon aluminum oxynitride; a Si-containing metal alloy, such as molybdenum-silicon alloys (e.g., MoSi₂) and niobium-silicon alloys (e.g., NbSi₂); and an oxide-oxide CMC. CMCs may further include a matrix reinforced with ceramic fibers, whisker, platelets, and chopped or continuous fibers.

The dopant may be selected from at least one of alumina (Al₂O₃), alkali oxide, or alkali earth oxide. These dopants may be present in an amount between 0.1 weight percent and about 5 weight percent with the balance being the rare earth disilicate. In certain embodiments when the dopant is alumina, it may be present in an amount between about 0.5 weight percent to about 3 weight percent. In an illustrative embodiment, the amount of alumina may be about 0.5 weight percent to about 1 weight percent. When the dopant is illustratively the alkali oxide, it may be present in an amount between about 0.1 weight percent to about 1 weight percent. Lastly, when the dopant is the alkali earth oxide, it may be present in an amount between about 0.1 weight percent and about 1 weight percent.

In further embodiments, system 2 may include a top coat that comprises various rare earth disilicate and monosilicate layer combinations (see, also, FIG. 3-10). The rare earth disilicate component has a composition of RE₂Si₂O₇ wherein RE is selected from the rare earth elements lutetium, ytterbium, thulium, erbium, holmium, dysprosium, terbium, gadolinium, europium, samarium, promethium, neodymium, praseodymium, cerium, lanthanum, yttrium, and scandium. The rare earth monosilicate component has a composition of RE₂SiO₅ where the RE is also selected from the rare earth elements lutetium, ytterbium, thulium, erbium, holmium, dysprosium, terbium, gadolinium, europium, samarium, promethium, neodymium, praseodymium, cerium, lanthanum, yttrium, and scandium. The function of this layer is to enhance the temperature capability of the EBC system. Dopants in the doped rare earth disilicate layer reduce the temperature capability, such as melting point and water vapor stability, of rare earth silicate.

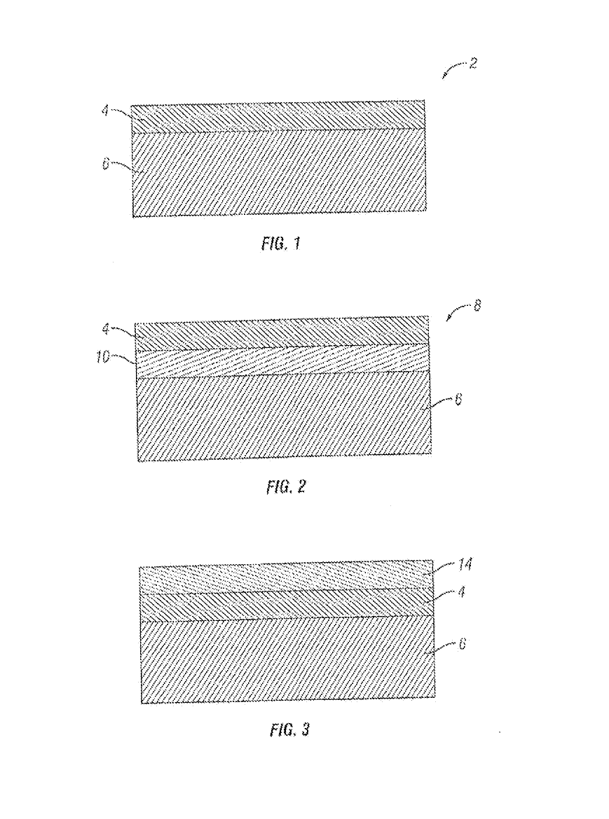

Another illustrative embodiment, as shown in FIG. 2, includes an environmental barrier coating system 8 located over CMC material 6 that includes doped rare earth disilicate layer 4 located over silicon layer 10. It is appreciated that silicon layer 10 is located between doped rare earth disilicate layer 4 and CMC material 6. It is further appreciated that the rare earth elements for disilicate layer 4 may be the same as that described with respect to layer 4 in FIG. 1. Additionally, the dopants for layer 4 in this embodiment, including the Al₂O₃, alkali oxide, and alkali earth oxide, may be the same. The dopants may also have the same characteristics as the previous embodiment such as weight percents as that described with respect to layer 4 in FIG. 1. Also, system 8 may include various rare earth disilicate and monosilicate top coat layer combinations, as described with respect to FIGS. 3-10. The thickness of the doped rare earth disilicate layer may be between about 0.5 mils to about 10 mils or about 1 mil to about 3 mils, as previously discussed. It is appreciated that the doped rare earth disilicate layer produces much less SiO₂ scale. Thick silica scale reduces EBC life by increasing coating stress which leads to early EBC spallation. Slow growth of silica scale under doped disilicate is attributed to stronger chemical bonding. It is believed that thick silica scale leads to high EBC stresses, which in turn leads to EBC spallation. Preliminary EBC steam-thermal-cycling life test supports this postulation as the steam-thermal-cycling life of silicon/doped disilicate EBC in 90% H₂O-balance O₂ at 2400° F. (1316° C.) has passed 4× life of silicon/Yb disilicate EBC test.

Another embodiment includes CMC material 6 coated with a rare earth disilicate and monosilicate top coat 14 over doped rare earth disilicate layer 4, is shown in FIG. 3. Similarly, as shown in FIG. 4, the same disilicate and monosilicate top coat 14 may be applied over doped rare earth disilicate layer 4 and silicon bond coat layer 10 which all coat CMC material 6. As previously discussed, it is appreciated that in rare earth disilicate and monosilicate layer 4 the rare earth disilicate has a composition of RE₂Si₂O₇ where the RE is selected from the rare earth elements including lutetium, ytterbium, thulium, erbium, holmium, dysprosium, terbium, gadolinium, europium, samarium, promethium, neodymium, praseodymium, cerium, lanthanum, yttrium, and scandium. Similarly, the monosilicate component of this layer has a composition of RE₂SiO₅ where the RE is also selected from the same rare earth elements. It is appreciated that this top coat 14 may be applied to any of the other embodiments disclosed herein. Layer 14 enhances the temperature capability of the EBC system. Dopants in the doped rare earth disilicate layer reduce the temperature capability, such as melting point and water vapor stability, of rare earth silicate.

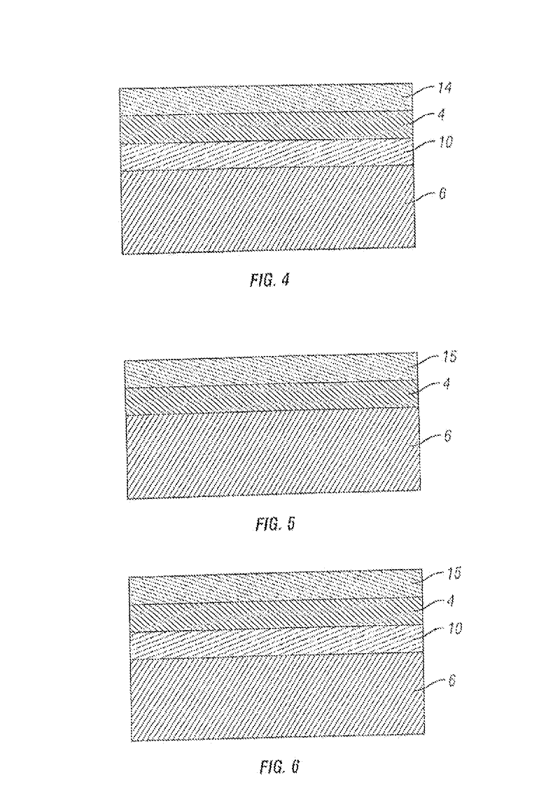

Another embodiment includes CMC material 6 coated with a rare earth disciliate top coat 15 over doped rare earth disilicate layer 4, is shown in FIG. 5. Rare earth disilicate layer 15 has a rare earth disilicate composition of RE₂Si₂O₇ where the RE is selected from the rare earth elements including lutetium, ytterbium, thulium, erbium, holmium, dysprosium, terbium, gadolinium, europium, samarium, promethium, neodymium, praseodymium, cerium, lanthanum, yttrium, and scandium. The embodiment in FIG. 6 is similar to that of FIG. 5 except that silicon bond coat 10 is located between doped rare earth disilicate layer 4 and CMC material 6.

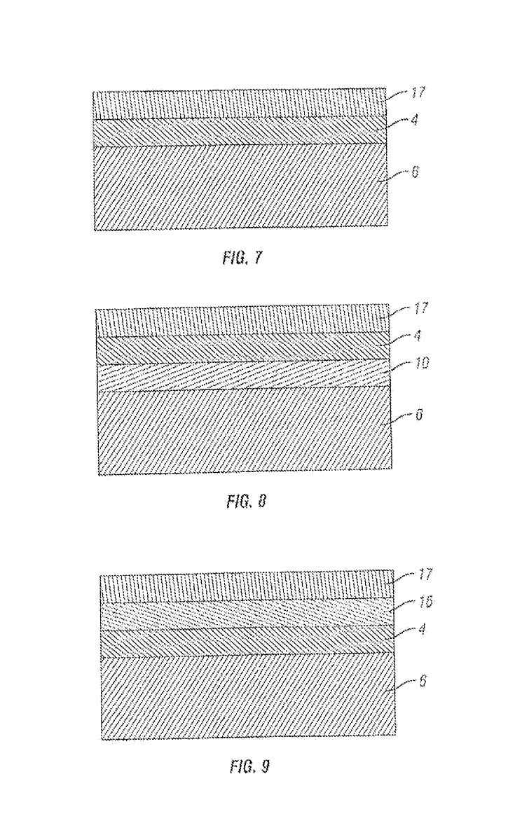

The embodiment shown in FIG. 7 includes a rare earth monosilicate layer 17 located over doped rare earth disilicate layer 4. Rare earth monosilicate layer 17 has a composition of RE₂SiO₅ where the RE is selected from the rare earth elements including lutetium, ytterbium, thulium, erbium, holmium, dysprosium, terbium, gadolinium, europium, samarium, promethium neodymium, praseodymium, cerium, lanthanum, yttrium, and scandium. The embodiment in FIG. 8 is similar to that shown in FIG. 7 except that silicon bond coat 10 is located between doped rare earth disilicate layer 4 and CMC material 6.

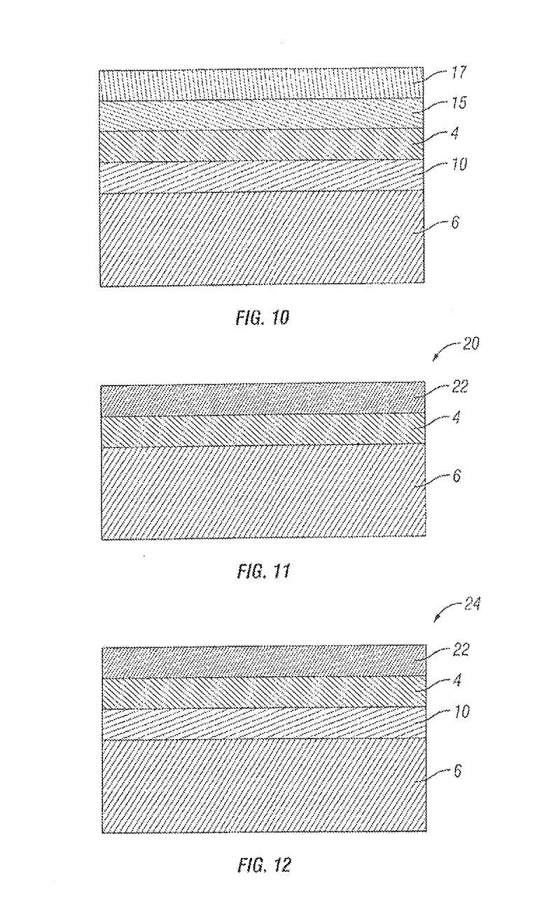

The embodiments shown in FIGS. 9 and 10 include a rare earth monosilicate layer 17 located over rare earth disilicate layer 15 which is located over doped rare earth disilicate layer 4. Like the other embodiments, the rare earth monosilicate layer 17 has a composition of RE₂SiO₅ where RE is selected from the rare earth elements including lutetium, ytterbium, thulium, erbium, holmium, dysprosium, terbium, gadolinium, europium, samarium, promethium, neodymium, praseodymium, cerium, lanthanum, yttrium, and scandium. Likewise, the rare earth disilicate layer 15 has a composition of RE₂Si₂O₇ where the RE is selected from the rare earth elements including lutetium, ytterbium, thulium, erbium, holmium, dysprosium, terbium, gadolinium, europium, samarium, promethium, neodymium, praseodymium, cerium, lanthanum, yttrium, and scandium. Silicon bond coat 10 is located between doped rare earth disilicate layer 4 and CMC material 6 in the embodiment shown in FIG. 10.

Another illustrative embodiment of the present disclosure includes a barrier coat system 20 having CMC material 6 coated with a calcium-magnesium aluminosilicate-resistant (CMAS-resistant) layer 22 overlaying doped rare earth disilicate layer 4, as shown in FIG. 11. The CMAS-resistant coating comprises a rare earth oxide, alumina, and silica. Optionally, the CMAS-resistant coating may further comprise at least one of Ta₂O₅, TiO₂, HfSiO₄, alkali oxide, or alkali earth oxide. The rare earth oxide in the CMAS-resistant coating comprises at least one of scandium, yttrium, lanthanum, cerium, praseodymium, neodymium, promethium, sambarium, europium, gadolinium, terbium, dysprosium, holmium, erbium, thulium, ytterbium, and lutetium. It is appreciated that pores may form in undoped disilicate layers as well as debond with the silicon bond coats. Pores are the result of CMAS-rare earth disilicate chemical reactions. The debonding is also the result of CMAS-rare earth disilicate chemical reactions. There is no direct correlation between pore formation and debonding except for the fact that both are the result of CMAS degradation.

Similarly, another embodiment of the long life, low cost environmental barrier coating includes system 24 which has a CMAS-resistant coating layer 22 overlaying doped rare earth disilicate layer 4 which overlays silicon bond coat layer 10 which is over CMC material 6, as shown in FIG. 12.

The CMAS-resistant layer may include a rare earth oxide, alumina, and silica where the rare earth oxide has a composition of RE₂O₃ where the RE is selected from the group of rare earth elements including lutetium, ytterbium, thulium, erbium, holmium, dysprosium, terbium, gadolinium, europium, samarium, promethium, neodymium, praseodymium, cerium, lanthanum, yttrium, and scandium. The CMAS-resistant layer may itself include a dopant that includes Al₂O₃ and SiO₂ where the Al₂O₃ is present in an amount between about 0.1 weight percent and about 5 weight percent and the SiO₂ is present in an amount between about 5 weight percent to about 25 weight percent. It is further appreciated that the Al₂O₃ may be present in a range between about 0.5 weight percent and about 3 weight percent, and the SiO₂ may be present in an amount between about 5 weight percent to about 20 weight percent, about 0.5 weight percent to about 1 weight percent, or about 10 weight percent and about 20 weight percent, respectively. The balance of those amounts is the rare earth oxide. In a further embodiment, the CMAS layer may include an oxide from the group of in at least one of Ta₂O₅, TiO₂, HfSiO₄, an alkali oxide or in alkali earth oxide. In another embodiment, the oxide may be present in an amount between about 0.1 weight percent and about 3 weight percent, or about 0.5 weight percent and about 1 weight percent. Illustratively, the CAS resistant layer may have a thickness of between about 0.5 mils to about 10 mils or about 1 mil to about 3 mils. These CMAS-resistant embodiments may also include the rare earth disilicate and monosilicate layer 14 with the same characteristics as that previously discussed with other embodiments.

Another illustrative embodiment of the present disclosure includes system 30 which has a barium-strontium-aluminosilicate layer 32 overlaying doped rare earth disilicate layer 4 overlaying CMC material 6, as shown in FIG. 13. The BSAS has the chemical formula 1-xBaO.xSO.Al₂O₃.2SiO₂ where 0≦x≧1.

When compared to a mullite/BSAS EBC, a doped rare earth silicate/BSAS EBG is significantly more manufacturing friendly because no substrate heating is required for the plasma spraying. The mullite/BSAS EGG requires heating the CMC substrate to >1000° C. for phase stability. The absence of substrate heating also translates to substantial cost reduction by eliminating the substrate heating apparatus, such as a high temperature furnace. Also compared to rare earth silicate BBC and mullite/BSAS EBC, doped rare earth disilicate/BSAS EBC offers longer thermal cycling life because dopants in rare earth disilicate facilitate stronger chemical bonding that translates into longer oxidation life.

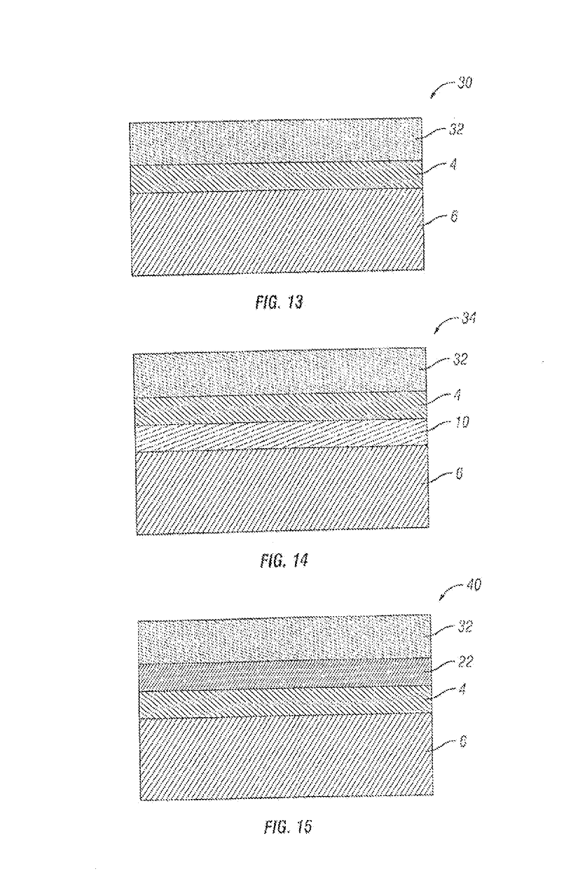

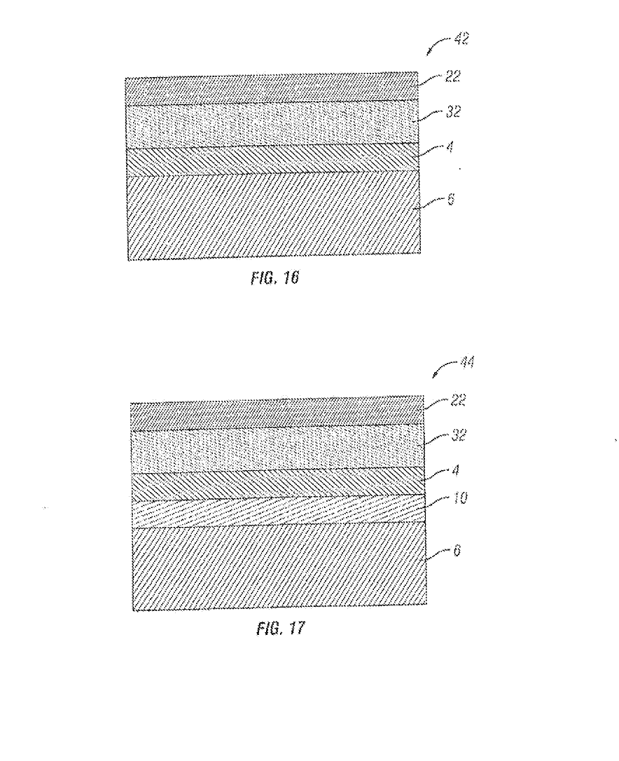

In another embodiment as shown in FIG. 14, system 34 includes BSAS layer 32 located over doped rare earth disilicate layer 4 which overlays silicon bond coat layer 10 which overlays CMC material 6. The composition of the disilicate layer along with the rare earth elements, dopants and their particular characteristics herein, as described with other embodiments may be applied to both systems 32 and 34.

Another embodiment of the present disclosure as shown in FIG. 15, includes system 40 which has BSAS layer 32 overlaying CMAS-resistant coat 22, which overlays doped rare earth disilicate layer 4, overlaying CMC material 6. Again, as with the other embodiments, the characteristics of the doped rare earth disilicate layer 4, its dopant, the composition and thicknesses of those layers, as well as the characteristics previously discussed with respect to the CMAS resistant layers may be applied to these layers shown in FIG. 15, as well. In a similar embodiment, as shown in FIG. 16, system 42 includes CMAS-resistant coat 22 overlaying BSAS layer 32, which overlays doped rare earth disilicate layer 4, which overlays CMC material 6.

In similar fashion, system 44, shown in FIG. 17, includes CMAS-resistant layer 22 overlaying BSAS layer 32 which overlays doped rare earth disilicate layer 4, which overlays silicon bond coat 10 overlaying CMC material 6. Again, the characteristics of CMAS-resistant layer 22, BSAS layer 32, doped rare earth disilicate layer 4, silicon bond coat layer 10 and CMC material 6 may include the characteristics as that previously described with respect to the other embodiments.

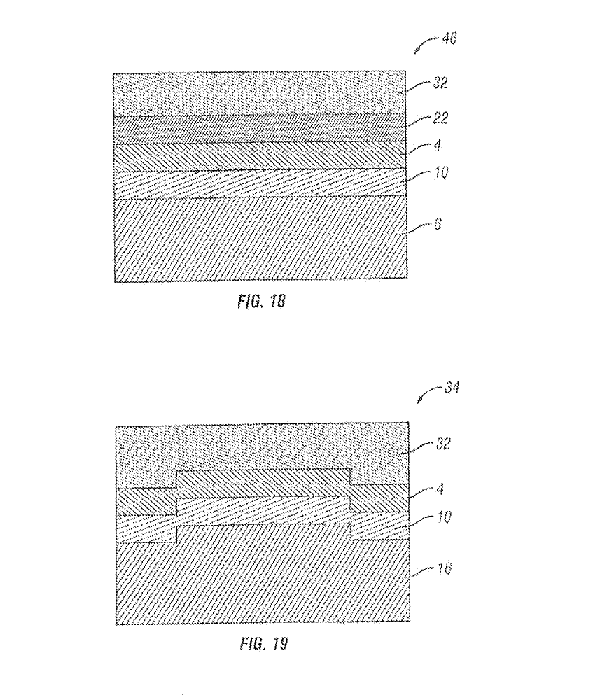

In the embodiment of FIG. 18, system 46 is similar to that described with respect to systems 42 and 44 except in this case BSAS layer 32 overlays CMAS-resistant coat 22, which overlays doped rare earth disilicate layer 4 overlaying silicon bond coat layer 10 on CMC material 6.

As part of the scope of all of the embodiments described herein, the CMC material 6 is not required to have a flat coatable surface. Each of these embodiments are configured to also accommodate a CMC material 6 having an irregular top surface, such as that shown in FIG. 19. This particular embodiment includes system 34 (see also FIG. 14) that includes BSAS layer 32 overlaying doped rare earth disilicate layer 4 and silicon bond coat 10. Again, this embodiment may include the characteristics of each of the layers as described with the previous embodiments including the compositions, the weight percents, thicknesses, etc., and may apply to such a three-dimensional, top surface, as previously shown herein. Further, the terms doped and dopant as used herein applies a conventional meaning wherein a composition forms a homogeneous chemistry and crystal structure.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

1. An environmental barrier coating for a ceramic matrix composite, the environmental barrier coating comprising:
a calcium-magnesium aluminosilicate-resistant layer;
a doped rare earth disilicate layer;
wherein the calcium-magnesium aluminosilicate-resistant layer is located over the doped rare earth disilicate layer;
wherein the doped rare earth disilicate layer is located between the calcium-magnesium aluminosilicate-resistant layer and the ceramic matrix composite;
wherein the doped rare earth disilicate layer includes a rare earth disilicate that has a composition of RE₂Si₂O₇, wherein RE comprises at least one of lutetium, ytterbium, thulium, erbium, holmium, dysprosium, terbium, gadolinium, europium, samarium, promethium, neodymium, praseodymium, cerium, lanthanum, yttrium, or scandium;
wherein the doped rare earth disilicate layer includes a dopant that includes at least one of Al₂O₃, an alkali earth oxide, or an alkali oxide;
wherein the dopant is present in an amount between about 0.1 weight percent (wt. %) and about 5 wt. %, the balance of the doped rare earth disilicate layer being the rare earth disilicate;
wherein the calcium-magnesium aluminosilicate-resistant layer comprises a rare earth oxide, wherein the rare earth oxide has a composition of RE₂O₃, wherein RE comprises at least one of lutetium, ytterbium, thulium, erbium, holmium, dysprosium, terbium, gadolinium, europium, samarium, promethium, neodymium, praseodymium, cerium, lanthanum, yttrium, or scandium;
wherein the calcium-magnesium aluminosilicate-resistant layer further includes Al₂O₃ and SiO₂;
wherein the Al₂O₃ in the calcium-magnesium aluminosilicate-resistant layer is present in an amount between about 0.1 wt. % and about 5 wt. %; and
wherein the SiO₂ in the calcium-magnesium aluminosilicate-resistant layer is present in an amount between about 5 wt. % and about 25 wt. %, with the balance of the CMAS-resistant layer being the rare earth oxide.

2. The environmental barrier coating of claim 1, wherein the calcium-magnesium aluminosilicate-resistant layer further comprises at least one of Ta₂O₅, TiO₂, or HfSiO₄.

3. The environmental barrier coating of claim 1, wherein the Al₂O₃ in the calcium-magnesium aluminosilicate-resistant layer is present in an amount between about 0.5 wt. % and about 3 wt. % and the SiO₂ in the calcium-magnesium aluminosilicate resistant layer is present in an amount between about 5 wt. % and about 20 wt. %.

4. The environmental barrier coating of claim 1, wherein the Al₂O₃ in the calcium-magnesium aluminosilicate-resistant layer is present in an amount between about 0.5 wt. % and about 1 wt. % and the SiO₂ in the calcium-magnesium aluminosilicate-resistant layer is present in an amount between about 10 wt. % and about 20 wt. %.

5. The environmental barrier coating of claim 1, wherein the calcium-magnesium aluminosilicate-resistant layer has a thickness of between about 0.5 mils and about 10 mils.

6. The environmental barrier coating of claim 1, wherein the doped rare earth disilicate layer comprises Al₂O₃ and wherein the Al₂O₃ in the doped rare earth disilicate layer is present in an amount between about 0.5 wt. % and about 3 wt. %

7. The environmental barrier coating of claim 1, wherein the doped rare earth disilicate layer comprises the alkali oxide, and wherein the alkali oxide in the doped rare earth disilicate layer is present in an amount between about 0.1 wt. % and about 1 wt. %.

8. The environmental barrier coating of claim 1, wherein the doped rare earth disilicate layer has a thickness of between about 0.5 mils to and about 10 mils.

9. The environmental barrier coating of claim 1, further comprising an uppermost top coat comprising at least one of a rare earth disilicate layer, a rare earth monosilicate layer, a dual-layered coat including a rare earth monosilicate layer over a rare earth disilicate layer, or a rare earth disilicate and rare earth monosilicate layer; wherein the rare earth disilicate has a composition of RE₂Si₂O₇, wherein RE comprises at least one of lutetium, ytterbium, thulium, erbium, holmium, dysprosium, terbium, gadolinium, europium, samarium, promethium, neodymium, praseodymium, cerium, lanthanum, yttrium, or scandium; and the rare earth monosilicate has a composition of RE₂SiO₅, wherein RE comprises at least one of lutetium, ytterbium, thulium, erbium, holmium, dysprosium, terbium, gadolinium, europium, samarium, promethium, neodymium, praseodymium, cerium, lanthanum, yttrium, or scandium.

10. The environmental barrier coating of claim 1, wherein the calcium-magnesium aluminosilicate-resistant layer further includes an alkali oxide.

11. The environmental barrier coating of claim 10, wherein the alkali oxide in the calcium-magnesium aluminosilicate-resistant layer is present in an amount between about 0.1 wt. % and about 1 wt. %.

12. The environmental barrier coating of claim 1, wherein the doped rare earth disilicate layer comprises the alkali earth oxide, and wherein the alkali earth oxide is present in an amount between about 0.1 wt. % and about 1 wt. %.

13. The environmental barrier coating of claim 1, further comprising a silicon coat layer, wherein the silicon coat layer is located between the doped rare earth disilicate layer and the ceramic matrix composite.

14. The environmental barrier coating of claim 2, wherein the at least one of Ta₂O₅, TiO₂, or HfSiO₄ is present in an amount between about 0.1 wt. % and about 3 wt. %.
